(19) United States
(12) Patent Application Publication
(10) Pub. No.: US 2012/0062495 A1
(43) Pub. Date: Mar. 15, 2012

(54) INPUT DEVICE

(75) Inventor: Ichiro Kajitani, Fukushima (JP)

(73) Assignee: KYOCERA CORPORATION, Kyoto (JP)

(21) Appl. No.: 13/321,793

(22) PCT Filed: May 25, 2010
(86) PCT No.: PCT/JP2010/003485

§ 371 Date: Nov. 21, 2011

(30) Foreign Application Priority Data
May 27, 2009 (JP) 2009-128233

(51) Int. Cl. G06F 3/041

(52) U.S. Cl. 345/173

(57) ABSTRACT

Provided is an input apparatus that initially assigns 26 candidates, “a” through “z”, to a touch unit 6, starting with a point P1. Subsequently, the input apparatus detects a drag operation from the point P1 to a point P2, and when a turn at the point P2 is detected, the input apparatus assigns a larger area than the area initially assigned to the letter “q”, which has been assigned to the point P2, and the letters “p”, “o”, “n”, “m”, and “l”, which correspond to locations traversed during the drag operation.

### TECHNICAL FIELD

The present invention relates to an input apparatus that receives a selection of a candidate from a touch unit.

### BACKGROUND ART

Conventionally, some mobile terminals such as a mobile phone and a mobile music player receive input when a display unit on which a touch unit is superimposed (display unit with a touch unit) is touched. In such touch input, a plurality of candidates are displayed on a display unit, each of the candidates is assigned a region of a touch unit, and a selection of a candidate is received in accordance with a point of the touch with, for example, a finger.

Also, there are a mobile terminal that receives input via a round touch pad, and a mobile terminal that is provided with a touch panel extending along one side of a display unit in a lengthwise direction thereof and one side of the display unit in a widthwise direction thereof.

In addition, there is a technology for aligning and displaying the letters of the alphabet A through Z on a display unit with a touch unit, receiving a selection of a letter in accordance with a point that has been touched, and scrolling through the letters of the alphabet to reach the received letter.

### SUMMARY OF INVENTION

### Technical Problem

However, when the number of candidates is large, for example, when the 26 letters of the alphabet are aligned and displayed on a display unit, a region occupied by each of the candidates is likely to be tight, since a size of the display unit (a size of a touch unit) is limited.

Generally, in order to realize touch input, it is necessary to design a touch unit in consideration of the thickness of a finger and manual dexterity of a user, a difference between a point that a user intends to touch and an actual point of the touch, and so on. In order that a user can select the intended candidate by touching with his/her finger, each candidate has to occupy a region whose size exceeds a certain size.

The above problem is not limited to a mobile terminal having a display unit with a touch unit. The problem also occurs when a touch unit is provided on a body that is different from a body on which a display unit is provided.

The present invention has been achieved in view of the above background, and aims to provide an input apparatus that receives a selection of a candidate via a touch unit and helps a user select a candidate as desired, even when the number of candidates is large.

### Solution to Problem

An input apparatus pertaining to the present invention includes a touch unit and comprises: detection unit detecting a touch on the touch unit and a movement of the touch while the touch is sustained on the touch unit; an assigning unit assigning a partial range of a detection region of the touch unit to each of a plurality of selectable candidates, the detection region being a region in which a touch is detectable; a display unit; a display control unit causing the display unit to display a candidate that has been assigned a partial range including a touch point at which the touch is performed; a judgment unit judging whether or not a direction of the movement of the touch has changed; and an assigned-range update unit, when the judgment unit has judged in the affirmative, enlarging a partial range assigned to a candidate corresponding to a touch point at which the touch is performed at the time of the change in the direction of the movement of the touch.

### Advantageous Effects of Invention

A structure of the input apparatus pertaining to the present invention enables a user to select a candidate with an easier operation.

### BRIEF DESCRIPTION OF DRAWINGS

FIGS. 1A and 1B each show an external appearance of a mobile phone 1.

FIGS. 2A and 2B are each a functional block diagram of the mobile phone 1.

FIG. 3 is a flowchart showing an operation pertaining to touch input.

FIG. 4 is a flowchart showing an operation pertaining to conversion of the case of letters in touch input.

FIGS. 5A-5D show a flow of touch input (alphabet).

FIGS. 6E-6H show a flow of touch input (alphabet).

FIGS. 7A-7C show a flow of touch input (number).

FIGS. 8A-8C show a flow of touch input (symbol).

FIGS. 9A-9C show a flow of touch input (hiragana).

FIGS. 10D-10F show a flow of touch input (hiragana).

FIGS. 11A and 11B show a flow of touch input (alphabet).

FIGS. 12A-12C show a flow of touch input (alphabet).

FIGS. 13A-13C show a flow of touch input (alphabet).

FIGS. 14A and 14B each show touch input using a touch screen 66.

FIG. 15 shows an external appearance of a mobile phone 101.

FIG. 16 shows an external appearance of a mobile phone 111.

### DESCRIPTION OF EMBODIMENT

An embodiment of the present invention is described below with reference to the drawings.

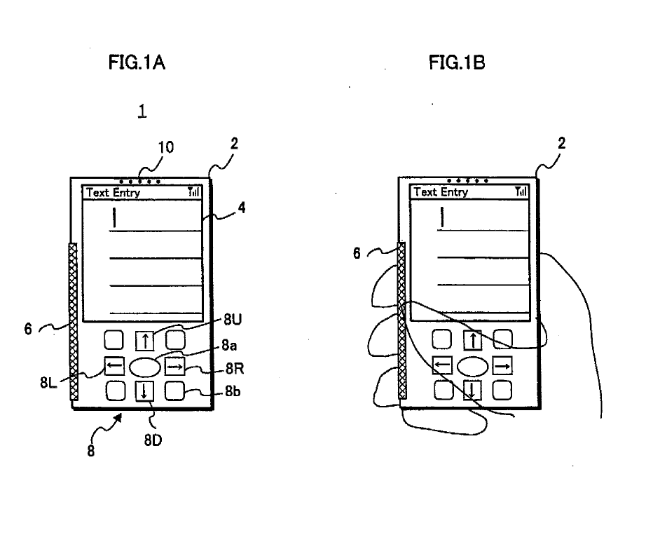

FIGS. 1A and 1B each show an external appearance of the mobile phone 1. FIG. 1B shows a body 2 held by a right hand of a user.

The mobile phone 1 is provided with the body 2 having a shape of a rectangular cuboid.

The body 2 is provided with a display unit 4, a touch unit 6, an operation key group 8, and a speaker 10. In each of FIGS. 1A and 1B, the display unit 4 is located at the upper part of the body 2, the touch unit 6 is located at the side surface of the left side of the body 2, the operation key group 8 is located at the lower part of the body 2, and the speaker 10 is located at the uppermost part of the body 2.

The display unit is, for example, an organic electroluminescence (organic EL) display unit, and a size thereof is 3.0 inches.

The touch unit 6 is a general capacitive touch unit, and an electric field is generated on a surface of the sensor. When the touch unit 6 is touched, a state of the electric field changes. Based on the change, the touch unit 6 can detect the presence and point of the touch.

The operation key group 8 consists of directional keys 8U, 8D, 8L, and 8R used for moving up, down, left, right, and the like, a determination key 8a used for making a determination, and function keys 8b used for calling specific functions (e.g., call function, camera function, and mail function).

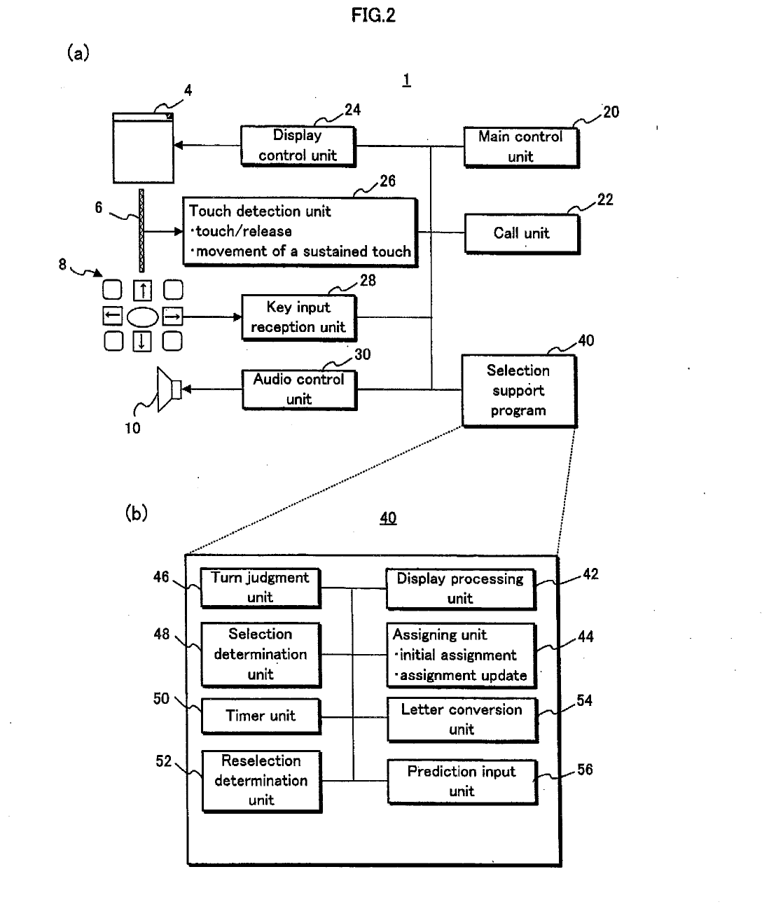

FIG. 2A is a functional block diagram of the mobile phone 1.

The mobile phone 1 is provided with a main control unit 20, a call unit 22, a display control unit 24, a touch detection unit 26, a key input reception unit 28, an audio control unit 30, and a selection support program 40.

The main control unit 20 consists of a ROM, a CPU, a RAM and the like, and controls units of the mobile phone 1. The ROM stores a control program, the CPU executes the control program, and the RAM is a work space for the execution.

The call unit 22 consists of a radio frequency (RF) circuit, and realizes a call function.

The display control unit 24 controls display of the display unit 4.

The touch detection unit 26 detects a touch on the touch unit 6, shift from a state in which the touch unit 6 is being touched to a state in which the touch unit 6 is not being touched (touch/release), a point of the touch/release, and in addition, a slide operation (movement of a sustained touch) on the touch unit 6.

The key input reception unit 28 receives input from the operation key group 8.

The audio control unit 30 causes the speaker 10 to output audio.

The selection support program 40 is provided with a display processing unit 42, an assigning unit 44, a turn judgment unit 46, a selection determination unit 48, a timer unit 50, a reselection determination unit 52, a letter conversion unit 54, and a prediction input unit 56, as shown in FIG. 2B.

The display processing unit 42 performs processing related to various display processing, and causes a screen of the display unit 4 to perform display via the display control unit 24.

The assigning unit 44 assigns candidates of divided letters (initial assignment) in correspondence with a region in which the touch unit 6 performs detection.

In addition, when the turn judgment unit 46 judges a movement as a turn, the assigning unit 44 updates the assigned area (assignment update).

The turn judgment unit 46 monitors a trail of a slide operation detected by the touch detection unit 26, and then judges whether the movement is a turn or not. For example, at a time when a direction of a slide operation vertically reverses, the turn judgment unit 46 judges the slide operation as a turn.

When the touch detection unit 26 detects a release, the selection determination unit 48 determines that a candidate that has been assigned to a point at which the release has occurred is selected (receives a selection).

When the selection determination unit 48 determines a selection, the timer unit 50 starts clocking a time. If the touch detection unit 26 detects a touch in vicinity to the release point before the timer unit 50 clocks a certain time period, the reselection determination unit 52 judges the touch as a reselection.

The letter conversion unit 54 converts the letters of the alphabet between upper case and lower case.

The prediction input unit 56 converts, for example, a line of input letters to a word. For example, when letters “ag” are input, the prediction input unit 56 presents words such as “again” and “age” as candidate words for conversion, using a forward match search method. Then the prediction input unit 56 converts the input letters to a candidate word selected among the presented words.

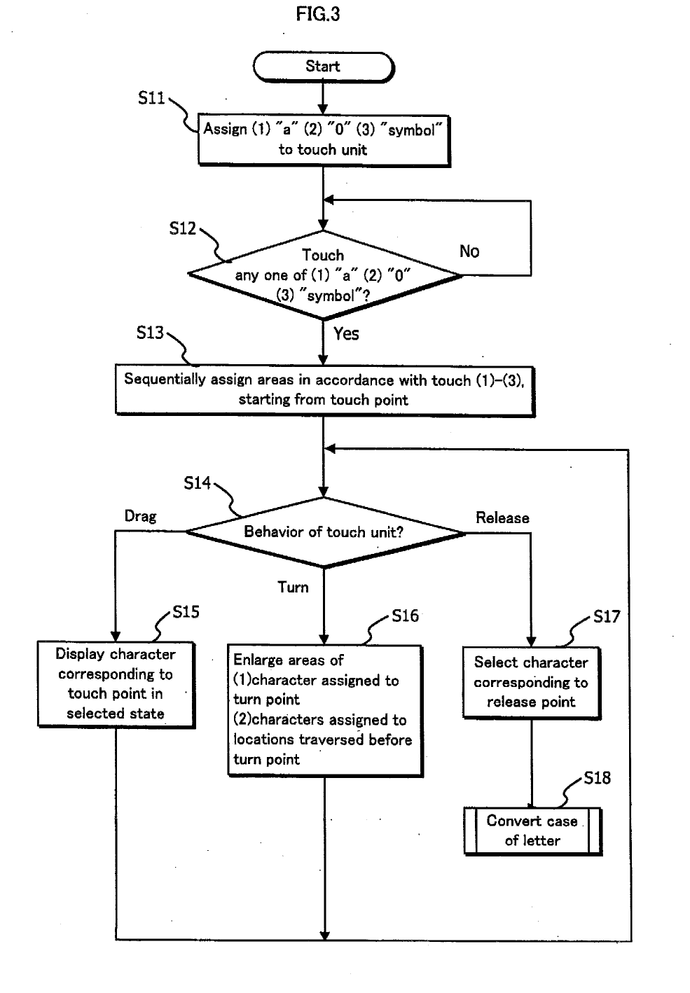

The following describes operations of the present embodiment in detail with reference to FIG. 3 to FIG. 6H.

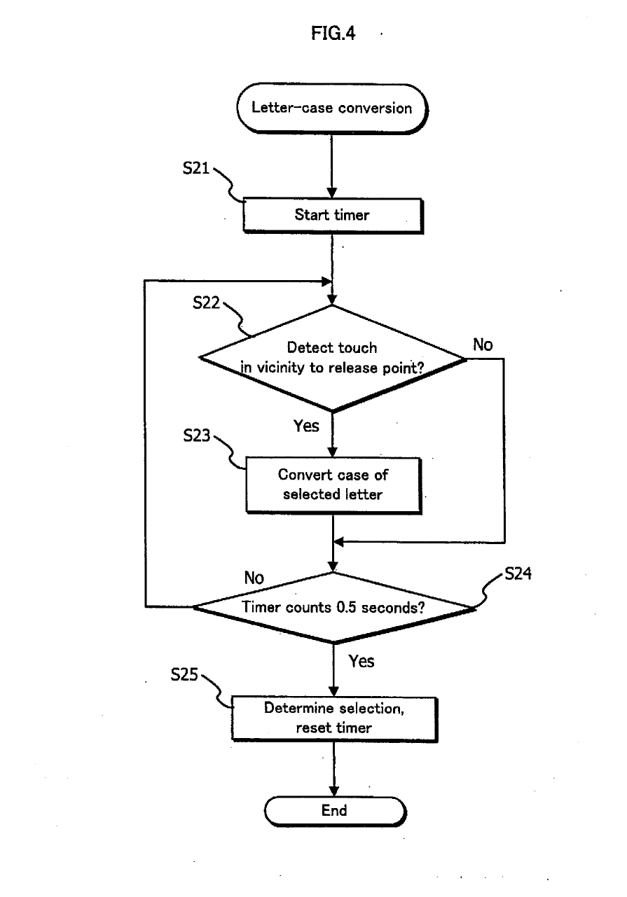

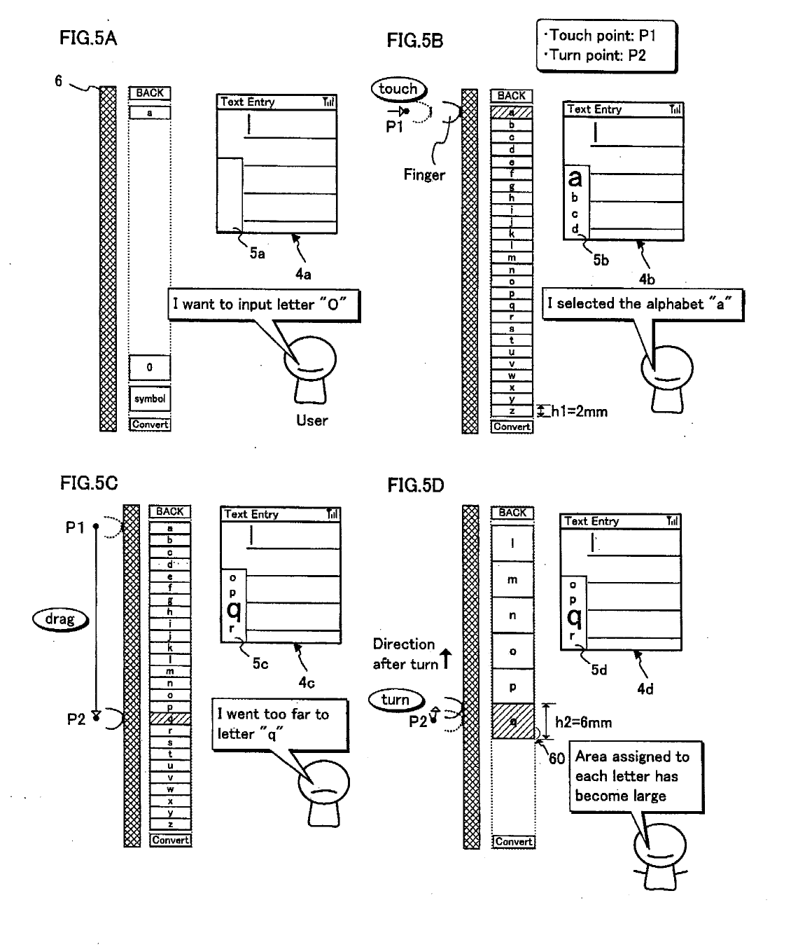

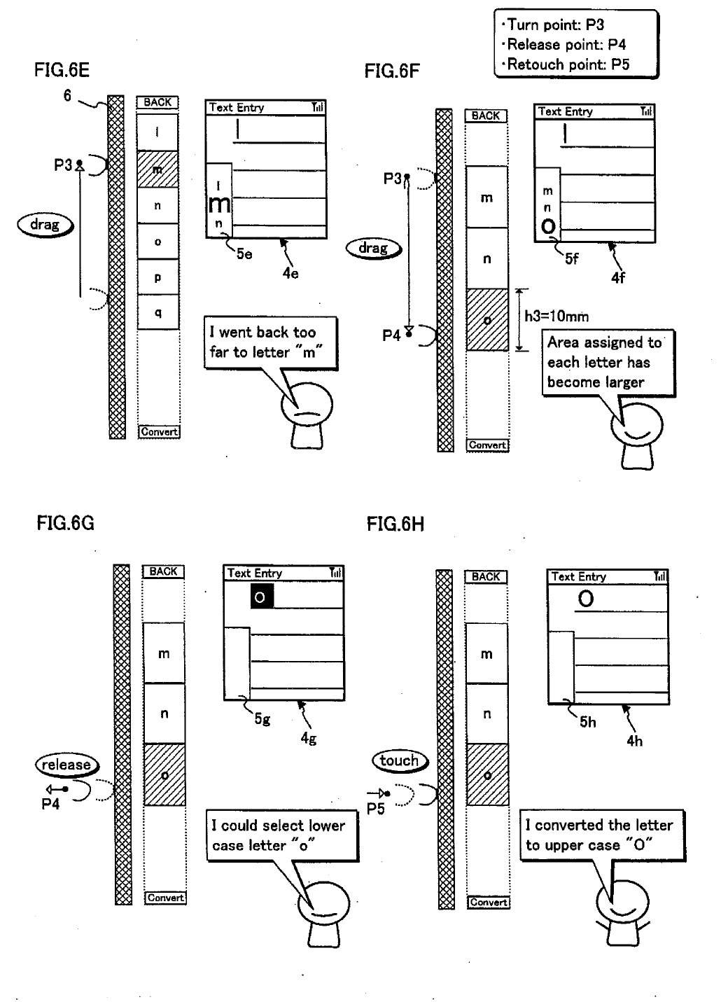

FIGS. 3 and 4 each are a flowchart showing an operation regarding touch input of the mobile phone 1. FIGS. 5A-5D and 6E-6H show a flow of the touch input corresponding to the flowcharts of FIGS. 3 and 4.

At a left side of each of FIGS. 5A-5D and 6E-6H, the touch unit 6 and areas of candidates assigned to the touch unit 6 are illustrated. At upper right parts of FIGS. 5A-5D and 6E-6H, screens 4a-4h and candidate windows 5a-5h are illustrated, respectively. At a lower right part of each of FIGS. 5A-5D and 6E-6H, a comment explaining an intention and a thought of a user who operates the mobile phone 1 is shown. These figures show a flow until the user intending to input an upper case letter “O” completes inputting the letter. Note that the comments of the user are only examples, and do not limit the general usage.

First, as shown in FIG. 5A, to a region in which the touch unit 6 can detect a touch, the assigning unit 44 assigns areas of “BACK” and “a” from the upper edge thereof, and areas of “convert”, “symbol”, and “0” from the lower edge thereof (S11). A length from the upper edge to the lower edge is approximately 60 mm.

Although the assignment of areas is not specifically displayed on the screen 4a, assume that a user knows in advance what is assigned to which point of the touch unit 6. Note that in order to guide a user, markings such as “a”, “0”, and “symbol” may be impressed on the body 2 in vicinity to the touch unit 6.

Here, a “convert” key is used to switch language. When the “convert” key is pressed for a longer time period (when the touch detection unit 26 detects a touch at the substantially same point for longer than a predetermined time period (for example, equal to or more than one second)), input of the alphabet and input of the hiragana characters, which are one of Japanese syllabograms, are switched.

A “BACK” key is used for a cancellation operation, for example.

An “a” key, a “0” key, and a “symbol” key are used for specifying characters to input. The “a” key, the “0” key, and the “symbol” key correspond to the letters of the alphabet, numbers, and symbols, respectively.

When the touch detection unit 26 receives a touch on any one of the above three keys (S12: Yes), the assigning unit 44 assigns an area sequentially divided, starting from a point that has been touched (touch point), in accordance with the touched key (S13). In the following, an explanation is provided for an example in which the “a” key has been received in step S12.

As shown in FIG. 5B, when the touch detection unit 26 receives a touch at a point P1 within an area to which the “a” key has been assigned, the assigning unit 44 assigns the 26 letters of the alphabet to the touch unit 6 in the alphabetic order (a, b, c, and so on), starting from the point P1. Each letter of the alphabet occupies an area whose height h1 is approximately 2 mm. Generally, in touch input, a height of an area occupied by one candidate is required to be equal to or more than 5 mm, for example, as a reference size. When the height is too small like 2 mm, a user has difficulty selecting a candidate as desired.

In addition, the display processing unit 42 displays the letter “a” assigned to the point P1, which is currently being touched, in boldface and larger than other letters “b”, “c”, and “d” in the candidate window 5b. As a result, it is clear that the letter “a” is in a state in which the letter is being selected (hereinafter, “selected state”).

Then as shown in FIG. 5C, when the touch detection unit 26 detects a slide operation, that is, a drag operation, from the point P1 to a point P2 (S14: drag), the display processing unit 42 switches a letter in a selected state, which is displayed in the candidate window 5c, from the letter “a” assigned to the point P1 to the letter “q” assigned to the point P2 in accordance with the slide operation (S15).

Subsequently, as shown in FIG. 5D, when the touch detection unit 26 detects a reversal of the direction of the slide operation, that is, a reversal from a downward direction to an upward direction at the point P2, the turn judgment unit 46 judges that a turn has occurred (S14: turn), and the assigning unit 44 enlarges areas of (i) the letter “q” assigned to the point P2, and (ii) the five letters “l”, “m”, “n”, “o”, and “p” traversed before the turn (S16).

In such enlargement, in principle, areas of letters are assigned only in a direction of a movement after the turn, starting from the point P2. However, as an exception, in view of a detection error of the touch unit 6a, the letter “q” is assigned to an area 60 that is located lower than the point P2.

A height h2 of an area assigned to each of the enlarged letters “q”, “l”, “m”, “n”, “o”, and “p” becomes 6 mm, which exceeds the above reference size of 5 mm. Therefore, a user can easily select a letter, compared with the initial assignment.

Subsequently, as shown in FIG. 6E, when the touch detection unit 26 detects a drag operation from the point P2 to a point P3 (S14: drag), the letter “m” assigned to the point P3 is displayed on the candidate window 5e (S15).

Then when the turn judgment unit 46 judges a movement at the point P3 as a turn (S14: turn), as shown in FIG. 6F, areas of (i) the letter “m” assigned to the point P3 and (ii) the two letters “n” and “o” assigned in a direction of a movement after the turn are enlarged (S16).

A height h3 of an area assigned to each of the enlarged letters “m”, “n” and “o” becomes 10 mm. That is, the height is further enlarged, compared with the first enlargement (FIG. 5D). As a result, a user can select a letter more easily.

Subsequently, when the touch detection unit 26 detects a drag operation from the point P3 to a point P4 (S14: drag, S15) and a release at the point P4 (S14: release), the selection determination unit 48 selects the letter “o” corresponding to the point at which the release has occurred (release point) (S17). After that, letter-case conversion processing (S18) starts.

As shown in FIG. 4, in the letter-case conversion processing, the timer unit 50 starts a timer (S21). If the touch detection unit 26 detects a touch at a point P5 in vicinity to the release point P4 (S22: Yes) before the timer counts 0.5 seconds (S24: Yes), the reselection determination unit 52 determines that a reselection has occurred. Then the letter conversion unit 54 converts the case of the selected letter “o” from lower case to upper case (S23).

When the timer counts 0.5 seconds (S24: Yes), the reselection determination unit 52 determines a selection of the lower-case letter “o”, and the timer unit 50 resets the timer. Note that the time period of 0.5 seconds is an example, and a user may change a setting.

As described above, according to the present embodiment, as shown in FIGS. 5A-5D and 6E-6H, areas assigned to letters that have been traversed before a turn are enlarged in accordance with judgment of a turn. Therefore, a user can easily select a desired letter, using the enlarged areas.

Furthermore, when a user who intends to select the letter “o” misjudges the distance and performs a drag operation to the letter “q”, traversing the letter “o”, the letter “q” and the letters such as “m”, “n”, “o” and “p”, which have been traversed before reaching the letter “q”, are enlarged.

Thus, since the areas of the letter “q” and the letters “m”, “n”, “o”, and “p” in vicinity to the latter “q” are enlarged, a user can easily return to and select a desired letter.

In addition, there is a usage example in which a user who well understands such an enlargement behavior first swiftly performs a drag operation to traverse a desired letter to turn, and then slowly performs a drag operation to select the desired letter, using areas enlarged by the turn.

### <Supplementary Explanations>

Although the embodiment of the present invention has been described, the present invention is not limited to the above embodiment. The present invention can be implemented in various embodiments for achieving the aim of the present invention and an aim relating to the aim of the present invention. For example, the following may be employed.

(1) In the embodiment, as shown in FIG. 5D, the areas of the letter “q” corresponding to the point P2 at which a turn has occurred (turn point) and the five letters from “l” to “p” immediately before the letter “q” are enlarged. However, the number of letters is not limited to five and may be optionally determined. For example, based on a distance from the turn point to the upper edge of the touch unit 6, if the distance is long, many letters may be assigned, and if the distance is short, few letters may be assigned.

On the other hand, effects can be achieved to a certain degree by enlarging at least two letters, that is, a letter assigned to the turn point (in FIG. 5D, “q”), and a letter traversed before reaching the turn point and assigned to an area adjacent to the turn point (in FIG. 5D, “p”).

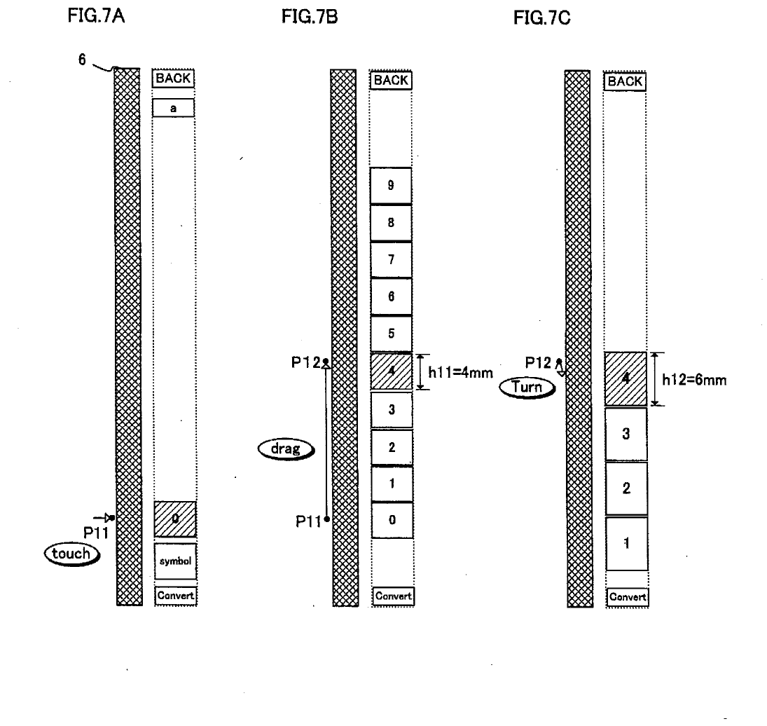

(2) The embodiment has described the example where, in step S12, the “a” key representing the alphabet is received and the letters of the alphabet are sequentially assigned, starting from the touch point (S13). On the other hand, when the “0” key representing the numbers is received, the numbers are sequentially assigned, starting from the touch point. A flow of touch input in this case is shown in FIGS. 7A-7C.

That is, when the touch detection unit 26 detects a touch at a point P11 at which the character “0” has been assigned in a default state (FIG. 7A), the assigning unit 44 sequentially assigns the numbers from 0 through 9 (i.e., 0, 1, 2, and so on) to the touch unit 6, starting from the touch point P11 (FIG. 7B).

Subsequently, when the touch detection unit 26 detects a drag operation from the touch point P11 to a point P12 and the turn judgment unit 46 judges a movement at the point P12 as a turn, the assigning unit 44 enlarges areas of the number “4” assigned to the turn point P12 and the numbers “3”, “2”, and “1” traversed during the drag operation before the turn (FIG. 7C).

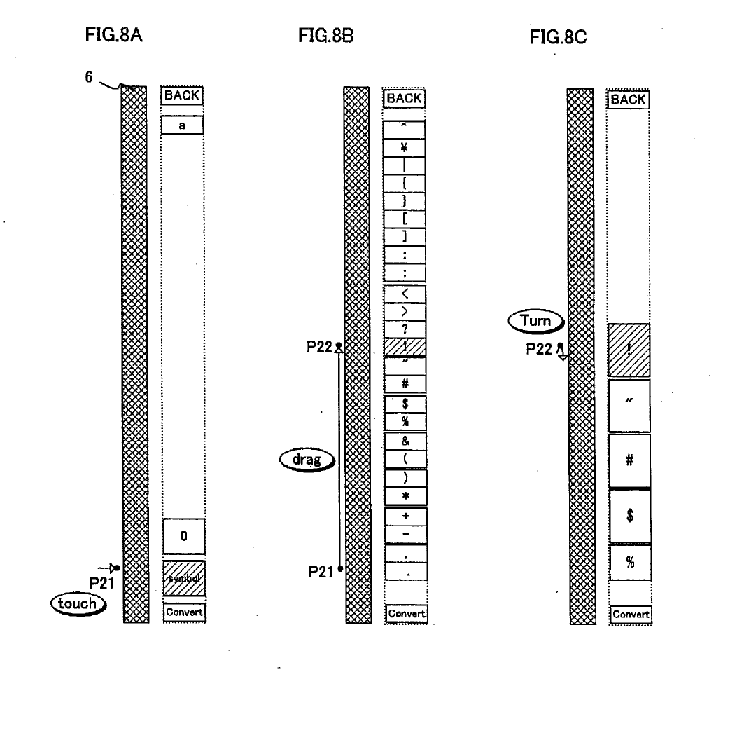

(3) Furthermore, a flow of touch input in which the “symbol” key representing symbols is received in step S12 is shown in FIGS. 8A-8C.

That is, when the touch detection unit 26 receives a touch at a point P21 at which the word “symbol” has been assigned in a default state (FIG. 8A), the assigning unit 44 assigns symbols in an order of “.”, “,”, “−”, and “+” to the touch unit 6, starting from the touch point P21 (FIG. 8B). Note that it is preferable that the order of symbols be easy for a user to memorize, using a character code table, for example.

Subsequently, if the touch detection unit 26 detects a drag operation from the touch point P21 to a point P22 and the turn judgment unit 46 judges a movement at the point P22 as a turn, the assigning unit 44 enlarges areas of the symbol “!” assigned to the turn point P22 and the symbols “″”, “#”, “$” and “%” traversed during the drag operation before the turn (FIG. 8C).

(4) As described in the embodiment, when the touch detection unit 26 detects that the “convert” key is pressed for a longer time period, the assigning unit 44 assigns the Japanese “A” key representing the hiragana characters, instead of the “a” key representing the alphabet.

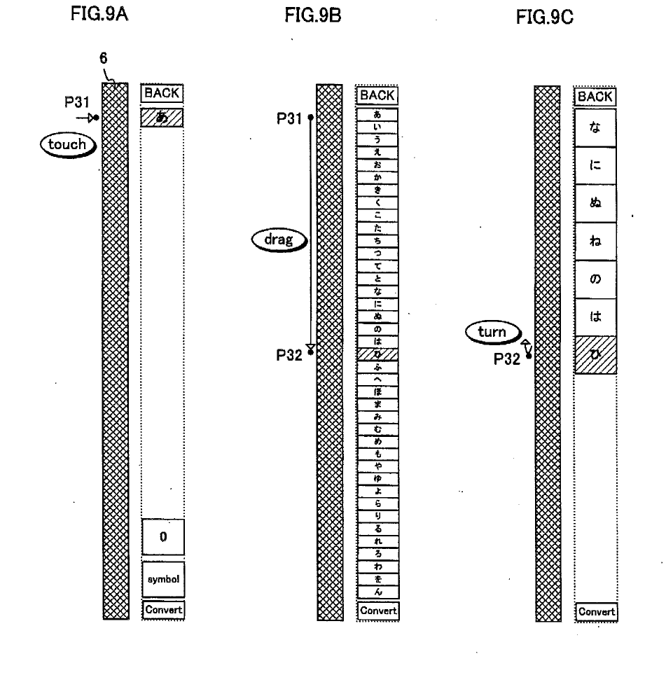

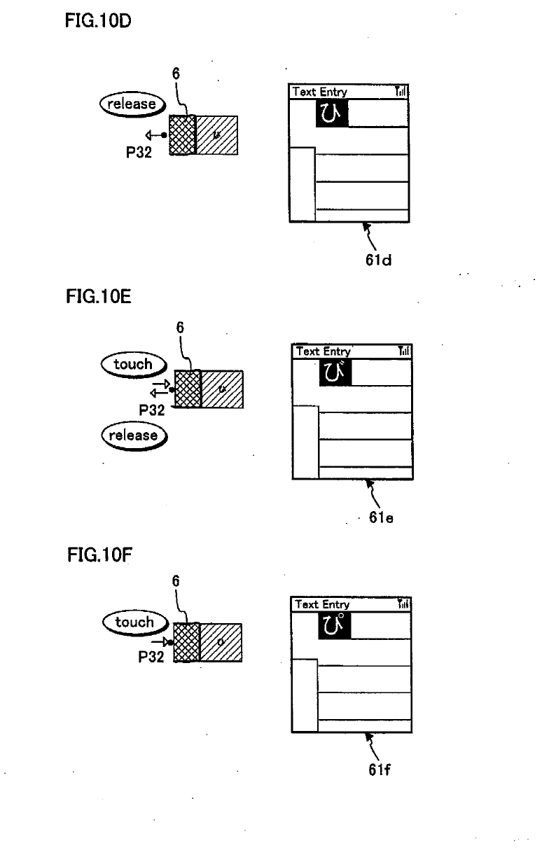

A flow of touch input using the hiragana characters is shown in FIGS. 9A-9C and 10D-10F. Note that a left side of each of FIGS. 10D-10F shows only an extracted part of the touch unit 6, to which the Japanese letter “HI” is assigned.

When the touch detection unit 26 receives a touch at a point P31 at which the Japanese letter “A” has been assigned in a default state (FIG. 9A), the assigning unit 44 assigns the hiragana characters in the Japanese syllabary order (i.e., “A”, “I”, “U” and so on) to the touch unit 6 toward the lower edge of the touch unit 6, starting from the touch point P31 (FIG. 9B).

Subsequently, if the touch detection unit 26 detects a drag operation from the touch point P31 to a point P32 and the turn judgment unit 46 judges a movement at the point P32 as a turn, the assigning unit 44 enlarges areas of the Japanese letter

“HI” assigned to the turn point P32 and the Japanese letters “NA”, “M”, “NU”, “NE”, “NO”, and “HA” traversed during the drag operation before the turn (FIG. 9C).

Then when the touch detection unit 26 detects a release at the point P32, the selection determination unit 48 selects the Japanese letter “HI” corresponding to the release point (FIG. 10D).

After the selection, as shown in screens 61d-61f, each time a release and a touch are repeated, the Japanese letter “HI” is cyclically converted in an order of a voiceless sound, a voiced sound, a p-sound, a voiceless sound, a voiced sound, a p-sound, and so on.

To be specific, when another touch is detected in vicinity to the point P32 before the timer counts 0.5 seconds after the selection of the letter, the letter conversion unit 54 converts the selected letter from the voiceless sound “HI” to a voiced sound “BI” (FIG. 10E).

Furthermore, when another touch is detected in vicinity to the point P32 before the timer counts 0.5 seconds after the conversion, the letter conversion unit 54 converts the selected letter from the voiced sound “BI” to a p-sound “PI” (FIG. 10F).

Furthermore, conversion of a letter may not be limited to the above, and conversion may include a contracted sound (geminate sound) such as conversion from the Japanese letter “YA” to a small letter “YA”, from the Japanese letter “A” to a small letter “A”, and from the Japanese letter “TSU” to a small letter “TSU”.

In conclusion, conversion of a letter may include, in addition to conversion between lower case and upper case, a conversion of syllables of a voiceless sound, a voiced sound, a p-sound, a contracted sound, a geminate sound, and so on.

Also, a point at which another touch is detected may be limited to the vicinity of a release point (FIG. 4: S22). However, it is only necessary to distinguish another touch from selection of other candidates such as the “BACK” key and the “convert” key, and accordingly another touch may be detected in all the area excluding the “BACK” key and the “a” key at the upper edge and the “0” key, the “symbol” key, and the “convert” key at the lower edge.

Note that in inputting the Japanese syllabograms, the hiragana characters are converted to the katakana characters, which are one of Japanese syllabograms, by selecting the “convert” key.

(5) In the embodiment, as shown in FIG. 5B, an area is assigned to each of the 26 candidates of the alphabet. In this way, when the number of candidates is large, an area assigned to each candidate is likely to be tight.

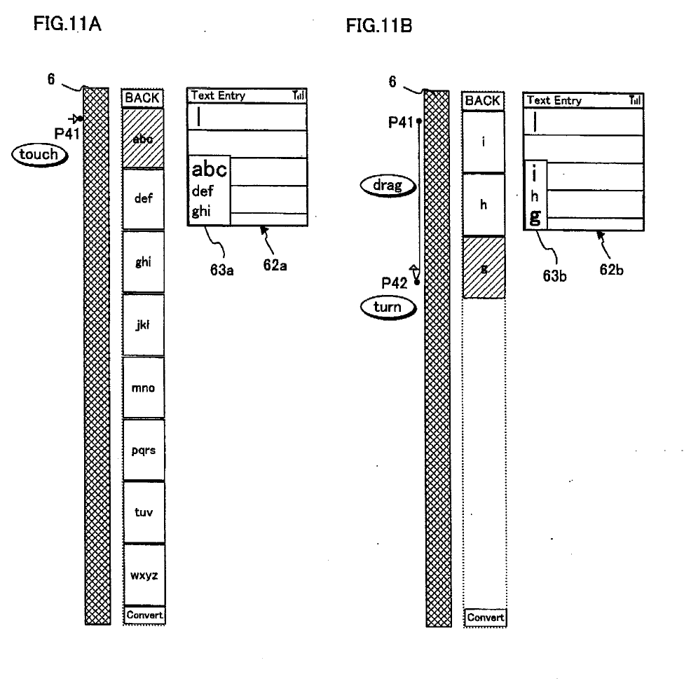

On the other hand, as shown in FIG. 11A, if three letters such as “abc”, “def” and so on or four letters are assigned to one area, it is possible to reduce the number of keys and areas assigned to respective keys are easily enlarged. This has an advantage especially when a length of the touch unit 6 is short. Note that a candidate window 63a in a screen 62a displays the letters “abc” in a selected state.

In FIG. 11B, a drag operation from a point P41 to a point P42 is detected and a subsequent movement at the point P42 is judged as a turn. Also, the letter group “ghi” assigned to the turn point P42 is expanded to the individual letters “g”, “h”, and “i”. In accordance with this, a candidate window 63b in the screen 62b shows expanded letters “g”, “h”, and “i”.

(6) When a turn point is close to the upper edge of the touch unit, a space for candidates that are enlarged and assigned, starting from the turn point, might be too small

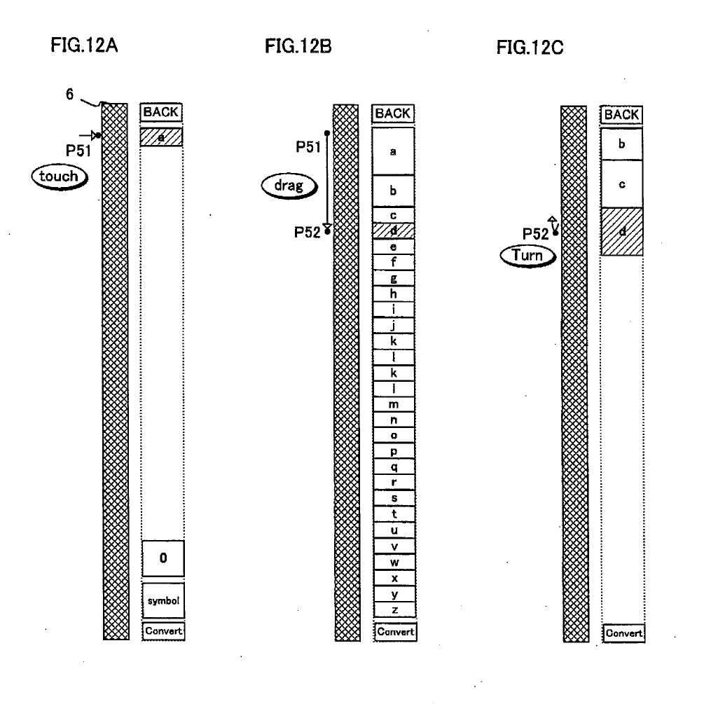

As shown in FIGS. 12A-12C, it is possible to handle such a problem by assigning larger areas to candidates close to the upper edge of the touch unit such as the letters “a” and “b”, compared with other letters (FIGS. 12A and 12B).

As shown in FIG. 12C, since each of areas of the candidates close to the upper edge has an enough space available, when a turn is detected at a point 52 after the drag operation from a point P51 to the point P52, it is possible to enlarge the letter “d” assigned to the point P52 and the letters “b” and “c” traversed before reaching the letter “d”.

(7) In the embodiment, as shown in FIG. 5D, an area of each of the letters assigned to the vicinity of the turn point is enlarged to have the same size. However, sizes of assigned areas may change in accordance with a distance to the turn point.

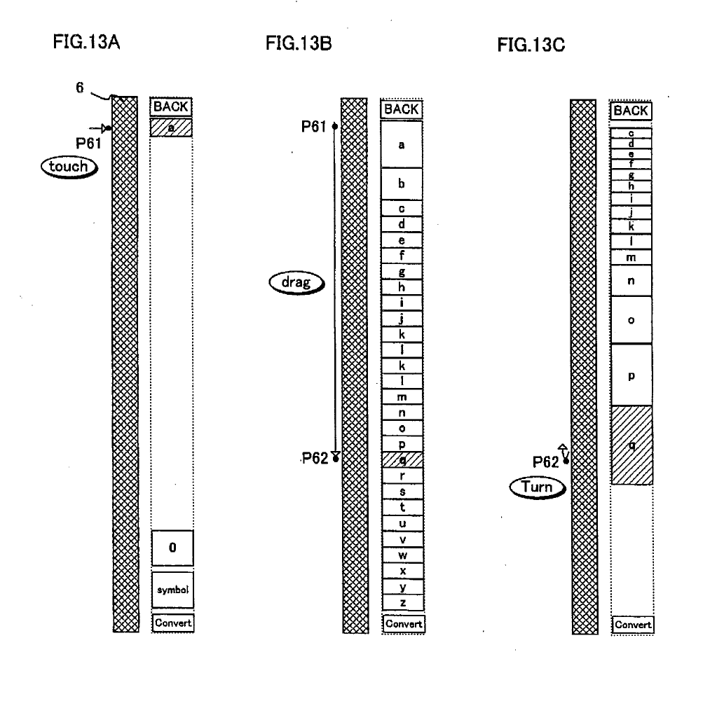

To be specific, as shown in FIGS. 13A-13C, when a movement at a point P62 is judged as a turn after a drag operation from a point P61 to the point P62, the letter “q” assigned to the point P62 and the letters “p”, “o”, “n”, “m”, “l”, and “k” are aligned in ascending order such that as a distance between the letter “q” and each of the above letters increases, an area assigned to each letter is reduced in size.

This makes areas of the letters in vicinity to the turn point P62 such as “q” and “p”, which are likely to be selected, larger and easily selected.

In addition, by assigning areas to the letters “c”, “d”, and “e” that are away from the turn point P62 even though the areas are small, it is still possible to select those letters.

Note that the areas assigned to the letters such as “c”, “d”, and “e” are too small and accordingly it is difficult to immediately select such letters. However, if the areas are enlarged once again when a turn is detected at a point corresponding to any one of the letters “c”, “d”, and “e”, the letters can be easily selected.

(8) Although not particularly mentioned in detail in the embodiment, the “BACK” key at the upper edge of the touch unit 6 is used in the following way.

While a text is being input, the “BACK” key is used for performing a backspace operation for moving one space backwards.

Especially, after the assigned areas are enlarged as shown in FIG. 5D, the “BACK” key is used to cancel input (return to the default state shown in FIG. 4A). Since the number of letters is decreased after the assigned areas are enlarged, the “BACK” key is used to select a letter that is out of the areas, for example.

Also, pressing the “BACK” key for a longer time period exits a text input mode.

(9) In the embodiment, the display unit 4 is provided on a body that is different from a body on which the touch unit 6 is provided. However, the present embodiment can be applied to a touch screen composed of a display unit having a touch unit superimposed thereon.

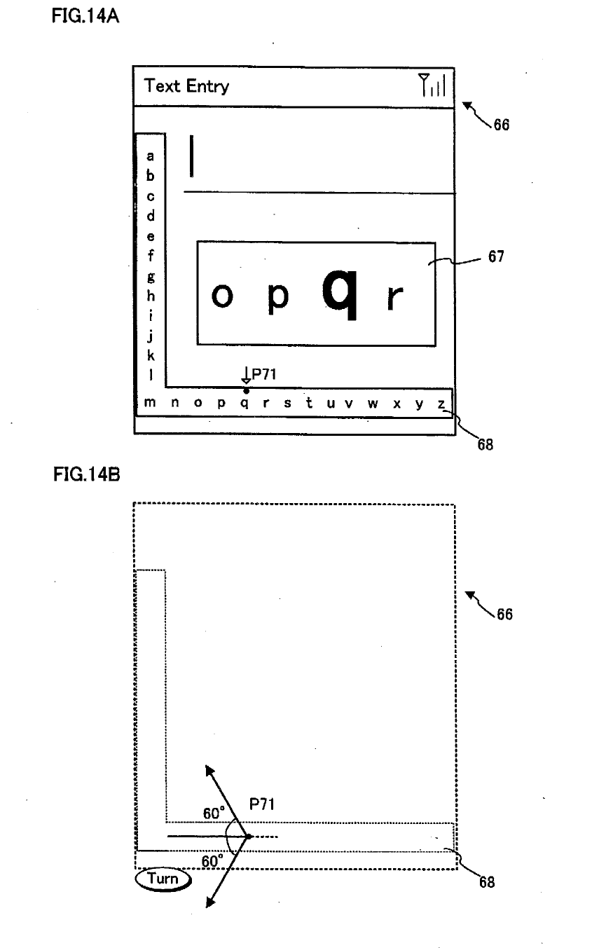

FIG. 14A shows, like FIG. 5D, a situation after a movement at a point at which the letter “q” has been assigned is judged as a turn. On a touch screen 66, a candidate window 67 and an index 68 are displayed.

The index 68 displays the letters from “l” to “q”. It is possible to select the letters from “l” to “q” by moving side to side during a sustained touch on each of the displayed letters. In FIG. 14A, a finger (unillustrated) touches a point P71, and accordingly the letter “q” assigned to the point P71 is displayed in a selected state within the candidate window 67.

In the case of a two-dimensional touch screen, when a direction of a trail of a movement is opposite to a direction of a trail of a preceding movement, the movement is basically judged as a turn in the same way as a one-dimensional touch screen. However, the opposite direction may not be strictly judged. As shown in FIG. 14B, if a direction of a trail of a movement after direction change is at an angle within ±60 degrees with respect to a direction of a trail of a preceding movement, the movement may be judged as a turn.

(10) In the embodiment, the touch unit 6 is provided at a left side of the body 2. However, two touch units may be provided at both sides of the body.

That is, a body 102 of a mobile phone 101 shown in FIG. 15 includes a touch unit 106L on a side surface of the left side thereof, and a touch unit 106R on a side surface of the right side thereof.

The touch unit 106L is supposed to be used by a right-handed user and the touch unit 106R is supposed to be used by a left-handed user.

In FIG. 15, the touch unit 106R is being used by a left-handed user. In this case, a touch detection function of the touch unit 106R is disabled in order to prevent unnecessary detection performed by the touch unit 106R.

(11) In the embodiment, the touch unit 6 is straight in shape. However, the shape is not limited to this.

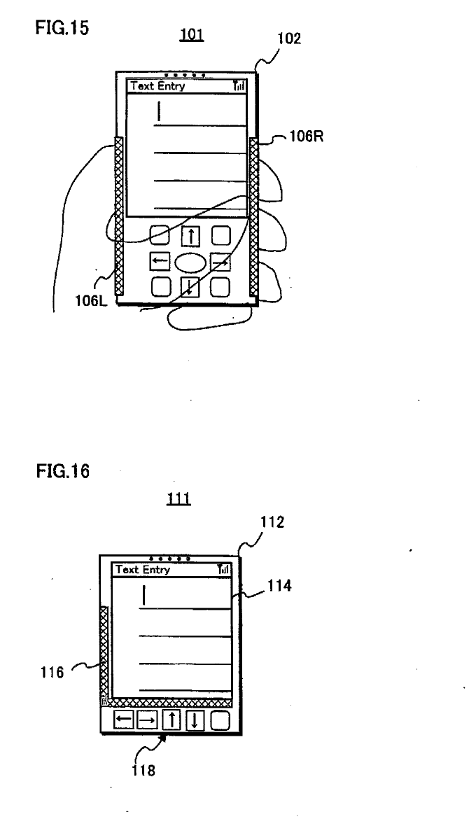

That is, a body 112 of the mobile phone 111 shown in FIG. 16 is provided with a display unit 114, an operation key group 118 consisting of up, down, left, and right keys and a determination key, and a touch unit 116 that has an L shape and extends along one side of the display unit 114 in a lengthwise direction thereof and one side of the display unit 114 in a widthwise direction thereof.

By making the touch unit 116 in the L shape, it is possible to secure a length of the touch unit, even if the body is small.

(12) In addition to input using the touch unit 6, the keys included in the operation key group 8 may be used.

For example, an instruction such as “convert”, “BACK”, and “cursor shift” may be assigned to the keys of the operation key group 8, and the directional keys 8L and 8R may set the magnification to enlarge areas.

(13) When the touch unit 6 performs input, the audio control unit 30 may output an operation sound while a candidate is being selected and a sound of a name of a candidate that is in a selected state from the speaker 10.

(14) In the embodiment, the mobile phone has been explained as an example of the input apparatus. However, the input apparatus is not limited to a mobile phone, and the embodiment can be used in a mobile terminal that receives touch input, such as a music player and any type of input apparatuses. Especially, it is effective to apply the embodiment to a mobile terminal having many restrictions on the length of the touch unit.

(15) The embodiment has described that, every time when a movement is judged as a turn, areas of candidates in vicinity to the turn point are enlarged. However, the number of enlargement of areas may be limited to once. In the case where the number of enlargement is limited to once, letters may not be assigned only in a direction of a movement after a turn, starting from a turn point, but letters may also be assigned in a direction opposite the direction of the movement after the turn.

(16) The embodiment has described that, every time when a movement is judged as a turn, areas of candidates in vicinity to a turn point are enlarged. However, as internal processing inside the apparatus, for example, the same behavior can be realized by, instead of tripling each area, setting a distance per unit time during a slide operation (speed in a slide operation) to ⅓ (apparently, each area is enlarged three times).

(17) The embodiment has described the example where, in order to indicate a selected state, a letter is displayed larger than other letters and in boldface. However, indication of the selected state is not limited to this, if the letter can be distinguished from other candidates. For example, a background color and a font color may be reversed.

In addition, candidates may be divided with a separator in units of block, or organized by color in units of block. As an example of division, in the case of the hiragana characters, candidates may be divided in units of rows such as the Japanese “A” row, the Japanese “KA” row and so on, and in the case of the alphabet, candidates may be divided in units of three, such as the letters “abc”, “def”, and so on. As an example of organization by color, odd-numbered candidates and even-numbered candidates may have different background colors or reversed colors.

### <Supplementary Explanations 2>

The present embodiment includes the following modes.

(1) An input apparatus including a touch unit, comprises: a detection unit detecting a touch on the touch unit and a movement of the touch while the touch is sustained on the touch unit; an assigning unit assigning a partial range of a detection region of the touch unit to each of a plurality of selectable candidates, the detection region being a region in which a touch is detectable; a display unit; a display control unit causing the display unit to display a candidate that has been assigned a partial range including a touch point at which the touch is performed; a judgment unit judging whether or not a direction of the movement of the touch has changed; and an assigned-range update unit, when the judgment unit has judged in the affirmative, enlarging a partial range assigned to a candidate corresponding to a touch point at which the touch is performed at the time of the change in the direction of the movement of the touch.

(2) the display control unit may cause the display unit to display, in a highlighted state, the candidate that has been assigned the partial range including the touch point, the change in the direction of the movement of the touch is a turn, and the assigned-range update unit may clear the assignment initially performed by the assigning unit, and enlarge, in addition to the enlarged partial range, partial ranges that are assigned to candidates neighboring the candidate corresponding to the touch point and that have been traversed during the movement of the touch before the judgment unit has judged in the affirmative.

This structure contributes to help a user more easily select a candidate to which a large area has been assigned.

(3) The input apparatus may further comprise a reception unit, when the detection unit detects that the touch has been released, receiving and confirming input of a candidate that has been assigned a partial range including a release point at which the touch has been released.

With this structure, it is possible to receive a selection of a candidate from a user, with an easy operation.

(4) The input apparatus may further comprises a conversion unit, and the plurality of candidates may be characters, and when another touch is detected within a predetermined time period after the reception unit receives the input of the candidate, the conversion unit may convert a case or a syllable of the input candidate.

(5) After the assigned-range update unit performs the enlargement, when the judgment unit has judged the movement of the touch as another turn, the assigned-range update unit may enlarge (i) a partial range assigned to a candidate that corresponds to a turn point at which said another turn has been performed and (ii) partial ranges that are assigned to candidates neighboring the candidate that corresponds to the turn point and that have been traversed during the movement of the touch before reaching the turn point.

This structure contributes to help a user more easily select a candidate to which a larger area has been assigned.

(6) The assigned-range update unit may clear the initial assignment of a partial range that is assigned to a candidate neighboring the candidate corresponding to the touch point and that has not been traversed during the movement of the touch before the judgment unit has judged in the affirmative.

(7) The plurality of candidates may be letters of the alphabet, and the assigning unit may align the letters of the alphabet in the alphabetical order, and assign a partial range of the detection region to each of the aligned letters of the alphabet.

(8) The plurality of candidates may be the hiragana syllabograms, and the assigning unit may align the hiragana syllabograms in the Japanese syllabary order, and assign a partial range of the detection region to each of the aligned hiragana syllabograms.

### INDUSTRIAL APPLICABILITY

The input apparatus pertaining to the present invention is useful to help a user select a candidate as desired, even when the number of candidates is large.

### REFERENCE SIGNS LIST

1, 101, 111 mobile phone

2, 102, 112 body

4, 114 display unit

4a-4h, 61d-61f, 62a, 62b, 64a, 64b screen of display unit

5a-5h candidate window

6, 106L, 106R, 116 touch unit

8 operation key group

20 main control unit

24 display control unit

26 touch detection unit

40 selection support program

42 display processing unit

44 assigning unit

46 turn judgment unit

48 selection determination unit

50 timer unit

52 reselection determination unit

54 letter conversion unit

66 touch screen

1. An input apparatus including a touch unit, comprising:
a detection unit detecting a touch on the touch unit and a movement of the touch while the touch is sustained on the touch unit;
an assigning unit assigning a partial range of a detection region of the touch unit to each of a plurality of selectable candidates, the detection region being a region in which a touch is detectable;
a display unit;
a display control unit causing the display unit to display a candidate that has been assigned a partial range including a touch point at which the touch is performed;
a judgment unit judging whether or not a direction of the movement of the touch has changed; and
an assigned-range update unit, when the judgment unit has judged in the affirmative, enlarging a partial range assigned to a candidate corresponding to a touch point at which the touch is performed at the time of the change in the direction of the movement of the touch.

2. The input apparatus of claim 1, wherein
the display control unit causes the display unit to display, in a highlighted state, the candidate that has been assigned the partial range including the touch point,
the change in the direction of the movement of the touch is a turn, and
the assigned-range update unit clears the assignment initially performed by the assigning unit, and enlarges, in addition to the enlarged partial range, partial ranges that are assigned to candidates neighboring the candidate corresponding to the touch point and that have been traversed during the movement of the touch before the judgment unit has judged in the affirmative.

3. The input apparatus of claim 2, further comprising
a reception unit, when the detection unit detects that the touch has been released, receiving and confirming input of a candidate that has been assigned a partial range including a release point at which the touch has been released.

4. The input apparatus of claim 3, further comprising
a conversion unit, wherein
the plurality of candidates are characters, and
when another touch is detected within a predetermined time period after the reception unit receives the input of the candidate, the conversion unit converts a case or a syllable of the input candidate.

5. The input apparatus of claim 2, wherein
after the assigned-range update unit performs the enlargement, when the judgment unit has judged the movement of the touch as another turn, the assigned-range update unit enlarges (i) a partial range assigned to a candidate that corresponds to a turn point at which said another turn has been performed and (ii) partial ranges that are assigned to candidates neighboring the candidate that corresponds to the turn point and that have been traversed during the movement of the touch before reaching the turn point.

6. The input apparatus of claim 2, wherein
the assigned-range update unit clears the initial assignment of a partial range that is assigned to a candidate neighboring the candidate corresponding to the touch point and that has not been traversed during the movement of the touch before the judgment unit has judged in the affirmative.

7. The input apparatus of claim 1, wherein
the plurality of candidates are letters of the alphabet, and
the assigning unit aligns the letters of the alphabet in the alphabetical order, and assigns a partial range of the detection region to each of the aligned letters of the alphabet.

8. The input apparatus of claim 1, wherein
the plurality of candidates are letters of the hiragana alphabet, and
the assigning unit aligns the hiragana syllabograms in the Japanese syllabary order, and assigns a partial range of the detection region to each of the aligned hiragana syllabograms.
